(19) United States
(12) Patent Application Publication
(10) Pub. No.: US 2025/0197245 A1
(43) Pub. Date: Jun. 19, 2025

(54) POSITIVE ELECTRODE ACTIVE MATERIAL POWDER AND LITHIUM SECONDARY BATTERY

(71) Applicant: TOYOTA JIDOSHA KABUSHIKI KAISHA, Toyota-shi (JP)

(72) Inventors: Ryosuke OHSAWA, Okazaki-shi (JP); Takahiko NINOMIYA, Miyoshi-shi (JP); Hiroo NOZAKI, Toyota-shi (JP); Taku KINOSHITA, Toyota-shi (JP)

(73) Assignee: TOYOTA JIDOSHA KABUSHIKI KAISHA, Toyota-shi (JP)

(21) Appl. No.: 18/886,064

(22) Filed: Sep. 16, 2024

(30) Foreign Application Priority Data
Dec. 18, 2023 (JP) 2023-213342

(51) Int. Cl. C01G 53/00; H01M 4/02; H01M 4/525; H01M 10/052

(52) U.S. Cl. CPC C01G 53/50; H01M 4/525; H01M 10/052; C01P 2002/22; C01P 2002/54; C01P 2006/40; H01M 2004/028

(57) ABSTRACT

The positive electrode active material powder of the present disclosure is used in a lithium secondary battery. The positive electrode active material powder is a positive electrode active material powder of a lithium secondary battery including a plurality of particles composed of a lithium transition metal oxide having a layered crystal structure. The thickness of the transition metal layers included in the lithium transition metal oxide is 2.06 Å to 2.19 Å. The thickness is calculated by Rietveld analysis using the emission X-ray diffractogram profile of the particle.

### CROSS-REFERENCE TO RELATED APPLICATION

This application claims priority to Japanese Patent Application No. 2023-213342 filed on Dec. 18, 2023, incorporated herein by reference in its entirety.

### BACKGROUND

### 1. Technical Field

The present disclosure relates to a positive electrode active material powder and a lithium secondary battery.

### 2. Description of Related Art

A lithium secondary battery is used for information communication technology (for example, a personal computer, smartphone or the like), onboard a vehicle, energy storage or the like.

Japanese Unexamined Patent Application Publication No. 2021-527919 (JP 2021-527919 A) discloses a lithium secondary battery. The lithium secondary battery includes a positive electrode, a negative electrode, a separation membrane interposed between the positive electrode and the negative electrode, and an electrolyte. The positive electrode includes a lithium composite transition metal oxide powder as a positive electrode active material. The lithium composite transition metal oxide has a layered structure. The content of nickel from among the total transition metals of the lithium composite transition metal oxide is from 50 atm % to 75 atm %. A rate of change of interlayer spacing of a lithium-oxygen layer, in a charge section from a SOC (state-of-charge) of 58% to 86% of the lithium composite transition metal oxide powder, is 3% or less.

### SUMMARY

In the lithium composite transition metal oxide disclosed in JP 2021-527919 A, when charging/discharging is performed, a discharge/intake of lithium ions is performed. Accordingly, when charging/discharging is repeatedly performed, the volume of the lithium composite transition metal oxide easily changes. As a result, there is a risk of cracks occurring in a positive electrode active material layer. When cracks occur in the positive electrode active material layer, the capacity of the lithium secondary battery decreases.

The present disclosure has been made in consideration of the circumstances. The problem to be solved by an embodiment of the present disclosure is to provide a positive electrode active material powder that can improve a capacity retention rate of a lithium secondary battery.

The problem to be solved by another embodiment of the present disclosure is to provide a lithium secondary battery excellent in a capacity retention rate.

The process for solving the problems includes the following embodiments.
1

A positive electrode active material powder used for a lithium secondary battery, the positive electrode active material powder including
a plurality of particles configured of a lithium transition metal oxide that has a layered crystal structure, in which
a thickness D_{TM} of a transition metal layer included in the lithium transition metal oxide is from 2.06 Å to 2.19 Å, and
the thickness D_{TM} shows a value calculated by a Rietveld analysis using an emitted light X-ray diffraction profile of the particles.
2

In the positive electrode active material powder described in 1,
the thickness D_{TM} is from 2.09 Å to 2.17 Å.
3

In the positive electrode active material powder described in 1 or 2,
the lithium transition metal oxide includes at least one of nickel (Ni), manganese (Mn), and cobalt (Co), and an additive element (M), and
the additive element (M) includes an element that has an ionic radius from 0.80 Å to 1.25 Å.
4

In the positive electrode active material powder described in 3,
the element that has the ionic radius includes strontium (Sr).
5

A lithium secondary battery
includes a positive electrode that includes the positive electrode active material powder described in any one of 1 to 4.

According to the present disclosure, a positive electrode active material powder capable of improving a capacity retention rate of a lithium secondary battery, and a lithium secondary battery excellent in a capacity retention rate, are provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining a layered crystal structure of a lithium transition metal oxide.

### DETAILED DESCRIPTION OF EMBODIMENTS

In the present disclosure, numerical ranges specified herein with “A-B,” “between A and B,” “(from) A to B,” etc., represent ranges, which include the minimum A and the maximum B. In the numerical ranges described in the present disclosures in a stepwise manner, an upper limit or a lower limit described in a numerical range may be replaced with an upper limit or a lower limit of a numerical range described in another stepwise manner. In the numerical ranges described in the present disclosure, the upper limit value or the lower limit value described in a certain numerical range may be replaced with the value shown in the examples. In the present disclosure, a combination of two or more preferred embodiments is a more preferred embodiment. In the present disclosure, the amount of each component means the total amount of a plurality of substances unless otherwise specified, when a plurality of substances corresponding to each component are present. In the present disclosure, the term “step” is included in the term as long as the intended purpose of the step is achieved, even if it is not clearly distinguishable from other steps as well as independent steps.

### (1) Positive Electrode Active Material Powder

The positive electrode active material powder of the present disclosure is used in a lithium secondary battery. The positive electrode active material powder includes a plurality of particles (hereinafter, also referred to as “TM particles”) composed of a lithium transition metal oxide having a layered crystalline structure. The thickness D_{TM} of the transition metal layers included in the lithium transition metal oxide is 2.06 Å to 2.19 Å. The thickness D_{TM} is calculated by Rietveld analysis using the emission X-ray diffractogram profile of the particle.

“Lithium transition metal oxide” refers to a compound in which lithium and a transition metal are cations and an oxide ion is an anion. “Transition-metal” refers to elements of Groups 3A to 7A, 8 and 1B in the Periodic Table.

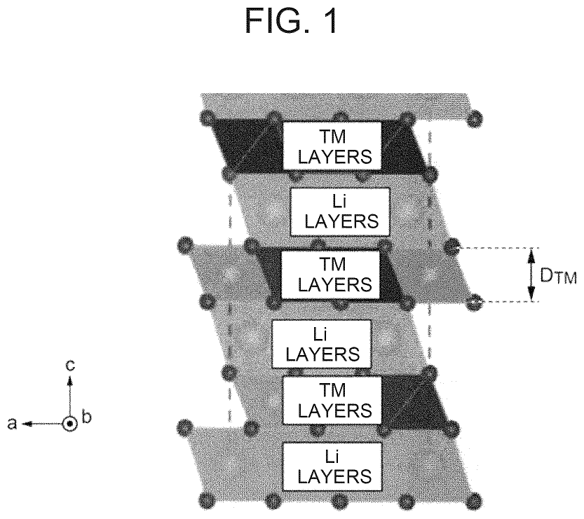

As shown in FIG. 1, the “layered crystal structure” indicates a crystal structure in which a transition metal layer containing lithium and a lithium single layer are alternately stacked via oxide ions. In FIG. 1, the symbol “D_{TM}” denotes the thickness D_{TM} of the transition metal layer, the “TM layer” denotes the transition metal layer, and the “Li layer” denotes the lithium-only layer. When the lithium transition metal oxide includes an additive element described later, the additive element is included in TM layers. The thickness D_{TM} of the transition metal layers is calculated in the same manner as described in the embodiment.

Since the positive electrode active material powder of the present disclosure has the above-described configuration, the capacity retention rate of the lithium secondary battery can be improved.

This effect is presumed to be due to, but not limited to, the following reasons.

In the present disclosure, the thickness D_{TM} of the transition metal layer is between 2.06 Å and 2.19 Å. Therefore, the volume of the lithium transition metal oxide is less likely to change even if charging and discharging are repeatedly performed. That is, cracking is less likely to occur in the positive electrode active material layer. As a result, it is presumed that the positive electrode active material powder of the present disclosure can improve the capacity retention rate of the lithium secondary battery.

The lithium transition metal oxide is obtained, for example, by mixing a transition-metal compound, a lithium compound (e.g., Li₂CO₃, LiOH) and an additive element described later to obtain a mixture, and calcining the obtained mixture. The transition-metal compound is obtained by hydrothermally synthesizing a transition-metal raw material (e.g., NiSO₄, CoSO₄, MnSO₄). In hydrothermal synthesis, unlike crystallization, the transition-metal feedstock is heated from 0.2 MPa to 1.0 MPa at 120° C. to 220° C. for 4 hours to 10 hours. The transition metal compound obtained by the hydrothermal synthesis (that is, the transition metal layer precursor) is more likely to grow in crystal than the transition metal compound obtained by crystallization. By using a transition metal compound obtained by hydrothermal synthesis and an additive element having a particular ionic radius (e.g., 0.80 Å to 1.25 Å), the thickness D_{TM} of the transition metal layers can be adjusted from 2.06 Å to 2.19 Å.

### (1.1) TM Particle

The positive electrode active material powder includes a plurality of TM particles. TM particles are composed of lithium transition metal oxides having a layered crystalline architecture.

The thickness D_{TM} of the transition metal layers included in the lithium transition metal oxide is preferably 2.09 Å to 2.17 Å. Accordingly, the positive electrode active material powder of the present disclosure can further improve the capacity retention rate of the lithium secondary battery. The thickness D_{TM} may be greater than or equal to 2.10 Å and may be 2.13 Å.

The lithium transition metal oxide preferably includes at least one of nickel (Ni), manganese (Mn), and cobalt (Co), and an additive element (M). The additive element (M) preferably includes an element having an ionic radius of 0.80 Å to 1.25 Å. Accordingly, the positive electrode active material powder of the present disclosure can further improve the capacity retention rate of the lithium secondary battery.

Examples of the element having an ionic radius of 0.80 Å to 1.25 Å include strontium (Sr), yttrium (Y), lanthanum (La), bismuth (Bi), calcium (Ca), cerium (Ce), and gadolinium (Gd). Examples of the element having an ionic radius of 0.80 Å to 1.25 Å include mercury (Hg), holmium (Ho), lutetium (Lu), sodium (Na), neodymium (Nd), lead (Pb), promethium (Pm), and strontium (Sr). Among them, the element having an ionic radius preferably includes at least one selected from the group consisting of Y, Sr, and La, and more preferably includes Sr. When the element having the ionic radius contains Sr, the positive electrode active material powder of the present disclosure can further improve the capacity retention rate of the lithium secondary battery.

The lithium transition metal oxide may be represented by the following formula (I):

Li₁₊ᵤNiₓCo_{y}Mn_{z}MₜO₂ Formula (1):

In Formula (I), the following relationships are satisfied: −0.05≤u≤0.50, x+y+z+t=1, 0.30≤x≤0.90, 0.05≤y≤0.50, 0.05≤z≤0.50, and 0<t≤0.10. M represents at least one additive element selected from the group consisting of Y, Sr, and La. x may be greater than or equal to 0.70. y may be from 0.05 to 0.15. z may be from 0.05 to 0.15. t may be 0<t≤0.06. M may be Sr.

TM particles contained in the positive electrode active material powder may be one kind or at least two kinds.

The mean particle size of TM particles may be from 1 μm to 20 μm or from 5 μm to 15 μm. The “average particle diameter” indicates a particle diameter (median diameter) corresponding to a cumulative frequency of 50% by volume from a fine particle side having a small particle diameter in a volume-based particle size distribution based on laser diffraction and light scattering.

The ratio of TM particles to the total amount of the positive electrode active material powder may be more than 50% by mass, may be 80% by mass or more, and may be 100% by mass.

### (1.2) Other Positive Electrode Active Material Particles

The positive electrode active material powder may include a plurality of other positive electrode active material particles in addition to the plurality of TM particles. The other positive electrode active material particles may be known positive electrode active material particles that differ from TM particles.

### (2) Lithium Secondary Battery

The lithium secondary battery of the present disclosure includes a positive electrode. The positive electrode includes the positive electrode active material powder of the present disclosure. Accordingly, the capacity retention rate of the lithium secondary battery of the present disclosure is excellent.

The lithium secondary battery of the present disclosure generally further includes a negative electrode and an ion conductive medium in addition to the positive electrode. The ion conducting medium is interposed between the positive electrode and the negative electrode and conducts carrier ions. Examples of the ion conductive medium include a non-aqueous electrolyte solution, a non-aqueous gel electrolyte solution, a solid ion conductive polymer, and an inorganic solid electrolyte.

Hereinafter, a lithium secondary battery (hereinafter, also referred to as a “nonaqueous battery”) using a nonaqueous electrolyte solution will be described.

### (2.1) Non-Aqueous Battery

The nonaqueous battery includes a negative electrode of the present disclosure, a positive electrode, a separator disposed between the positive electrode and the negative electrode, and a nonaqueous electrolyte.

### (2.1.1) Positive Electrode

The positive electrode may include a positive electrode mixture layer, and may further include a positive electrode current collector (e.g., aluminum foil). The positive electrode mixture layer is laminated on at least one main surface of the positive electrode current collector. The positive electrode mixture layer includes the positive electrode active material powder of the present disclosure.

The positive electrode mixture layer includes the positive electrode active material powder of the present disclosure. The positive electrode mixture layer may further include a known conductive material (e.g., carbon black, etc.), trilithium phosphate, a binder (e.g., polyvinylidene fluoride, etc.).

### (2.1.2) Negative Electrode

The negative electrode includes a negative electrode current collector, and may or may not further include a negative electrode mixture layer.

When the negative electrode does not have the negative electrode mixture layer, the negative electrode current collector includes a main surface on which lithium metal is deposited during charging. Specifically, lithium ions contained in the nonaqueous electrolyte solution receive electrons on the negative electrode current collector by charging, and lithium metal is deposited. The deposited lithium metal dissolves as lithium ions in the nonaqueous electrolyte solution by discharge. The lithium ions contained in the nonaqueous electrolytic solution may be at least one of ions derived from a lithium salt to be described later and ions supplied from the positive electrode active material by charging.

When the negative electrode has the negative electrode mixture layer, the negative electrode mixture layer is laminated on at least one main surface of the negative electrode current collector (for example, copper foil or the like). The negative electrode mixture layer includes a negative electrode layer active material (e.g., carbon (e.g., natural graphite, artificial graphite), a compound capable of alloying with lithium (e.g., silicon, tin, etc.)) capable of absorbing and desorbing charge carriers. The negative electrode mixture layer may further contain, if necessary, a conductive material for enhancing electron conductivity, a binder, an electrolyte support salt (lithium salt) for enhancing ion conductivity, a polymer electrolyte, and an additive. The conductive material for increasing the electron conductivity is, for example, acetylene black or the like. The binder is, for example, polyvinylidene fluoride. Examples of the additive include trifluoropropylene carbonate and the like. The negative electrode may have a known configuration.

### (2.1.3) Separator

The separator maintains a gap between the positive electrode and the negative electrode to prevent the occurrence of a contact short circuit, and allows lithium ions to pass through the separator. Examples of the separator include a porous resin sheet and a nonwoven fabric. Examples of the material of the porous resin sheet include polyolefins (polypropylene, polyethylene, and the like). Examples of the material of the nonwoven fabric include polypropylene, polyethylene terephthalate, and methylcellulose. The separator may have a known configuration.

### (2.1.4) Nonaqueous Electrolyte

The non-aqueous electrolyte solution may include a non-aqueous solvent and a lithium salt. Examples of the lithium salt include LiClO₄, LiAsF₆, LiPF₆, LiBF₄, LiCF₃SO₃, LiN(FSO₂)₂, and LiN(CF₃SO₂)₂. Examples of the non-aqueous solvent include cyclic carbonates, chain carbonates, cyclic esters, chain esters, and ethers. Examples of the cyclic carbonates include ethylene carbonate and the like. Examples of the chain carbonates include dimethyl carbonate and ethyl methyl carbonate. Examples of the cyclic ester include γ-butyrolactone and γ-valerolactone. Examples of the chain esters include methyl formate and methyl acetate. Examples of the ethers include dimethoxyethane and ethoxymethoxyethane. The nonaqueous electrolyte may contain an additive (for example, vinylene carbonate, lithium bis(oxalato)borate, or the like).

### (2.1.5) Case

Non-aqueous batteries usually have a case. The case contains a positive electrode, a negative electrode, a separator, and a nonaqueous electrolyte. The case is not particularly limited, and examples thereof include a laminate film (for example, an aluminum sheet, etc.), a battery can (for example, a cylindrical shape, a square shape, a coin shape, etc.), and the like.

Hereinafter, the present disclosure will be described in more detail with reference to Examples, but the disclosure of the present disclosure is not limited to these Examples.

### [1] Examples 1 to 5, Comparative Example 2, Comparative Example 4, and Comparative Example 5

### [1.1] Melting of Raw Materials

Nickel sulfate (NiSO₄), cobalt sulfate (CoSO₄) and manganese sulfate (MnSO₄) were dissolved in ion-exchanged water to obtain an aqueous NCM solution. The molar ratio (Ni:Co:Mn) (molar ratio) of Ni to Co to Mn was 8:1:1. The total content of nickel-sulfate, cobalt-sulfate and manganese-sulfate in the aqueous NCM solution was 0.2 mol %.

### [1.2] Hydrothermal Synthesis

An aqueous NCM solution and an aqueous ammonia solution (NH₃) were placed in the reactor, and nitrogen-substituted with stirrer. As a result, a mixed aqueous solution was obtained. Sodium hydroxide (NaOH) was added into the reactor vessel to make pH of the mixed aqueous solution alkaline. The precipitation reaction was allowed to proceed while pH and temperature of the mixed aqueous solution in the reaction vessel was controlled to be constant, and NCM hydroxide was precipitated. After completion of the precipitation reaction, dehydration was performed under the following temperature and pressure conditions, and hydrothermal synthesis (preliminary calcination) was performed. This resulted in a hydrothermal composition.

### Hydrothermal Synthesis Conditions

Temperature: 120° C. to 220° C.
Time: 4 hours to 10 hours
Pressure: 0.2 MPa to 1.0 MPa

After the hydrothermal composition was cooled, NCM hydroxide powder was removed from the hydrothermal composition by filtration, ion-exchanged water was added and dispersed by a spoon, and washed with water. The washed product was filtered to remove NCM hydroxide powder. Dry at 110° C. for 12 hours and evaporate the water. This gave a dry product of NCM hydroxide powder.

### [1.3] Li Material Mixing

The additive elements shown in Table 1, the dry matter of NCM hydroxide powder, and Li raw material (lithium carbonate (Li₂CO₃)) were mixed in a mortar at the ratios shown in Table 1. Firing was performed in a muffle furnace at 800° C. to 1100° C. for 10 hours. It was ground in a mortar and crushed to a predetermined particle size. As a result, a positive electrode active material powder was obtained. The positive electrode active material powder was composed of a plurality of particles composed of a lithium transition metal oxide having a layered crystal structure.

### [1.4] Measuring Thickness D_{TM} of The Transition Metal layer

### [1.4.1] XRD Measurement

X-ray diffraction (XRD) measurement was performed for the positive electrode active material powder. As a result, radiation XRD diffractogram was obtained. The beamline BL5S2 of the Aichi Synchrotron Radiation Center was used for the XRD measurement. Specifically, the positive electrode active material powder was filled into a capillary to prepare a capillary sample. The capillary-sample was set in the measurement jig, and under the following measurement conditions, XRD measurement was performed for the positive electrode active material powder.

### [1.4.1.1] Measurement Conditions

Measured energy: 15 keV
Threshold: 7.5 keV to 10 keV
2θ range: 10° to 90°

### [1.4.2] Thickness D_{TM} of Transition Metal Layer

Rietveld analysis was performed on the radiation XRD diffracted data. For the Rietveld analysis, a general purpose Rietveld analysis program “Fullprof” was used. By using “Fullprof”, the lattice parameters and atomic coordinates of the material can be calculated. In detail, the c-axis length (Cₕ) and the z-coordinate (Z_{OXY}) of oxygen when Chi² is the minimum value are obtained. “Chi²” indicates a convergence index obtained by fitting the radiation XRD diffracted data using the least squares method. “When Chi² takes the minimum value” indicates when the separation between the radiation XRD diffracted data and the profile fitting is the minimum.

The thickness D_{TM} of the transition metal layer contained in the lithium transition metal oxide was calculated by the following Equation (A). The measurement results are shown in Table 1.

$$Equation ( A )$$

$$Thickness {D}_{TM} of the transition metal layer = 2 \times [ ( 1 / 3 ) - {Z}_{OXY} ] \times {C}_{h}$$

### [2] Comparative Example 1 and Comparative Example 3

### [2.1] Melting of Raw Materials

In the same manner as in Example 1, an aqueous NCM solution was obtained.

### [2.2] Crystallization

A reaction solution prepared by adjusting pH using sulfuric acid and ammonia-water was prepared in the reaction vessel. An aqueous sodium hydroxide solution was prepared as a pH adjusting solution. NCM aqueous solution was added to the reaction solution at a predetermined rate while the reaction solution was stirred, and neutralized with pH adjusting solution. As a result, a crystallized material was obtained. The crystallized material was washed with water, filtered, and dried to obtain composite hydroxide particles (precursor particles).

### [2.3] Li Material Mixing

The additive elements shown in Table 1, the obtained precursor particles, and Li raw material (Li₂CO₃) were mixed in a mortar at the ratios shown in Table 1. Firing was performed at 700° C. for 10 hours in a baking furnace (muffle furnace). It was ground in a mortar and crushed to a predetermined particle size. As a result, a positive electrode active material powder was obtained. The positive electrode active material powder was composed of a plurality of particles composed of a lithium transition metal oxide having a layered crystal structure.

### [2.4] Measuring Thickness D_{TM} of Transition Metal Layer

In the same manner as in Example 1, the thickness D_{TM} (interlayer spacing) of the transition metal layer contained in the lithium transition metal oxide was calculated. The measurement results are shown in Table 1.

### [3] Evaluation

A lithium secondary battery was prepared as described below, and the capacity retention rate was measured.

### [3.1] Lithium Secondary Battery

### [3.1.1] Positive Electrode

A positive electrode slurry was prepared by mixing a positive electrode active material powder, acetylene black as a conductive material, and a binder-containing solution. “Binder-containing solution” refers to a mixed solution of a binder and a solvent. A positive electrode slurry was applied to a positive electrode current collector using a film applicator with a film thickness adjusting function (manufactured by Allgood Co., Ltd.) to obtain a coated product with a positive electrode current collector. The coated product with a positive electrode current collector was dried using a dryer at 80° C. for five minutes to obtain a positive electrode. The positive electrode is formed by laminating a positive electrode current collector and a positive electrode mixture layer in this order.

### [3.1.2] Negative Electrode

A negative electrode slurry was prepared by mixing natural graphite as a negative electrode active material, acetylene black as a conductive material, and a binder-containing solution. The negative electrode slurry was applied to a negative electrode current collector to obtain a coated product with a negative electrode current collector. The coated material with a negative electrode current collector was dried using a dryer at 80° C. for 5 minutes to obtain a negative electrode. The negative electrode is formed by laminating a negative electrode current collector and a negative electrode mixture layer in this order.

### [3.1.3] Nonaqueous Electrolyte

To the mixed solvents, LiPF₆ as an electrolyte was added to obtain a non-aqueous electrolyte solution. The mixed solvents consist of ethylene carbonate (EC), dimethyl carbonate (DMC) and ethyl methyl carbonate (EMC). The volume ratio (EC:DMC:EMC) (volume %) of EC to DMC to EMC was 3:4:3. LiPF₆ in the non-aqueous electrolyte was 1.0 M (mol/L).

### [3.1.4] Separator

A known separator was prepared as the separator.

### [3.1.5] Battery

A lithium secondary battery was prepared by using a positive electrode and a negative electrode, and then opposed to each other via a separator and sealed with a laminate together with a non-aqueous electrolyte solution.

### [3.2] Capacity Retention Rate

0.3 C constant-current constant-voltage charge (CCCV) was performed for 100 cycles on the lithium secondary battery. The battery capacity at one cycle (hereinafter, also referred to as “initial capacity”) and the battery capacity after 100 cycles (hereinafter, also referred to as “100 cycle capacity”) were measured. The capacity retention rate was calculated from the following Equation (B). The results are shown in Table 1. The acceptable range of capacity retention rate is greater than 77%.

$$Equation ( B )$$

$$Capacity retention rate ( \% ) = ( 100 cycles after cycle / initial capacity ) \times 100.$$

### [4] Results

TABLE 1

| | Lithium transition metal oxide with layered crystal structure | | | | | | | | |
|---|---|---|---|---|---|---|---|---|---|
| | | Additive | | | | | | | |
| | | element | | Ratio | | | | | Capacity |
| | | | Ionic | Additive | | | | | retention |
| | D_{TM} | | radius | element | Ni | Co | Mn | Synthetic | rate |
| | Å | Type | Å | mol % | mol % | mol % | mol % | method | % |
| Comparative | 1.95 | — | — | 0.0 | 80.0 | 10.0 | 10.0 | Crystallization | 70 |
| Example 1 | | | | | | | | | |
| Comparative | 1.98 | — | — | 0.0 | 80.0 | 10.0 | 10.0 | Hydrothermal | 75 |
| Example 2 | | | | | | | | synthesis | |
| Comparative | 2.01 | Fe | 0.55 | 1.0 | 79.2 | 9.9 | 9.9 | Crystallization | 75 |
| Example 3 | | | | | | | | | |
| Comparative | 2.04 | Al | 0.54 | 1.0 | 79.2 | 9.9 | 9.9 | Hydrothermal | 77 |
| Example 4 | | | | | | | | synthesis | |
| Comparative | 2.21 | K | 1.38 | 1.0 | 79.2 | 9.9 | 9.9 | Hydrothermal | 72 |
| Example 5 | | | | | | | | synthesis | |
| Example 1 | 2.07 | Y | 0.90 | 1.0 | 79.2 | 9.9 | 9.9 | Hydrothermal | 91 |
| | | | | | | | | synthesis | |
| Example 2 | 2.09 | Sr | 1.18 | 0.1 | 79.9 | 10.0 | 10.0 | Hydrothermal | 93 |
| | | | | | | | | synthesis | |
| Example 3 | 2.12 | Sr | 1.18 | 1.0 | 79.2 | 9.9 | 9.9 | Hydrothermal | 93 |
| | | | | | | | | synthesis | |
| Example 4 | 2.17 | Sr | 1.18 | 5.0 | 76.2 | 9.5 | 9.5 | Hydrothermal | 94 |
| | | | | | | | | synthesis | |
| Example 5 | 2.11 | La | 1.03 | 1.0 | 79.2 | 79.2 | 79.2 | Hydrothermal | 92 |
| | | | | | | | | synthesis | |

In Table 1, the ratio of Example 4 represents the ratio obtained by adding 5 mol % of the additive element to 100 mol % of the sum of the molar ratio of Ni to Co to Mn (Ni:Co:Mn=8:1:1).

### [4.1] Comparative Example 5 from Comparative Example 1

In Comparative Examples 1 to 5, the thickness D_{TM} of the transition metal layers was outside the range of 2.06 Å to 2.19 Å. Therefore, the capacity retention rates of Comparative Examples 1 to 5 were not more than 77%.

As a result, it was found from Comparative Example 1 that the positive electrode active material powder of Comparative Example 5 was not a “positive electrode active material powder capable of improving the capacity retention rate of the lithium secondary battery”.

### [4.2] Example 1 to Example 5

In Examples 1 to 5, the thickness D_{TM} of the transition metal layers ranged from 2.06 Å to 2.19 Å. Therefore, the capacity retention rates of Examples 1 to 5 were more than 77%.

As a result, it was found that the positive electrode active material powders of Examples 1 to 5 were “positive electrode active material powders capable of improving the capacity retention rate of a lithium secondary battery”.

What is claimed is:

1. A positive electrode active material powder used for a lithium secondary battery, the positive electrode active material powder comprising a plurality of particles configured of a lithium transition metal oxide that has a layered crystal structure, wherein
a thickness of a transition metal layer included in the lithium transition metal oxide is from 2.06 Å to 2.19 Å, and
the thickness shows a value calculated by a Rietveld analysis using an emitted light X-ray diffraction profile of the particles.

2. The positive electrode active material powder according to claim 1, wherein the thickness from 2.09 Å to 2.17 Å.

3. The positive electrode active material powder according to claim 1, wherein:
the lithium transition metal oxide includes at least one of nickel, manganese, and cobalt, and an additive element; and
the additive element includes an element that has an ionic radius from 0.80 Å to 1.25 Å.

4. The positive electrode active material powder according to claim 3, wherein the element that has the ionic radius includes strontium.

5. A lithium secondary battery comprising a positive electrode that includes the positive electrode active material powder according to claim 1.
